(19) United States
(12) Patent Application Publication
(10) Pub. No.: US 2007/0260417 A1
(43) Pub. Date: Nov. 8, 2007

(54) System and method for selectively affecting a computing environment based on sensed data

(75) Inventors: Robert Starmer, San Jose, CA (US); Stuart G. Aaron, Los Altos, CA (US); Douglas A. Gourlay, Sausalito, CA (US)

Correspondence Address: Trellis Intellectual Property Law Group, PC, 1900 EMBARCADERO ROAD, SUITE 109, PALO ALTO, CA, 94303, US

(73) Assignee: Cisco Technology, Inc., San Jose, CA (US)

(21) Appl. No.: 11/386,922

(22) Filed: Mar. 22, 2006

(51) Int. Cl. G01K 17/00

(52) U.S. Cl. 702/136

(57) ABSTRACT

A system and method for affecting computing resources. The method includes sensing variables associated with spatially dispersed computing resources and providing sensed data in response thereto. Subsequently the spatially dispersed computing resources are selectively automatically affected based on sensed variables associated with the computing resources. In a specific embodiment, the method further includes determining if the sensed data meet a predetermined criterion or criteria and providing one or more control signals in response thereto. The specific method further includes moving virtual machines associated with computing resources that meet the predetermined criterion or criteria to computing resources that do not meet the predetermined criterion or criteria. The sensed data may include temperature, and the predetermined criteria or criterion may include a predetermined threshold beyond which temperature data is considered to meet the predetermined criterion. In an illustrative embodiment, the method further includes selectively activating one or more devices, such as cooling systems, that are adapted to alter sensed variables to cause the sensed data to no longer meet the predetermined criterion or criteria.

### BACKGROUND OF THE INVENTION

This invention is related in general to computing and more specifically to systems methods for affecting computing environments, such as by affecting temperature distribution.

Systems for affecting computing environments are employed in various demanding applications including cooling systems for data centers of high density compute systems. Such applications often require stringent operating environments to maximize system reliability and capacity.

Systems for maintaining optimum computing environments are particularly important in data-center applications, where businesses rely upon maximum network reliability and capacity for business success. A data-center network often contains plural network devices, such as switches, load balancers, firewalls, and routers which are located in plural server racks. The datacenter also contains plural compute servers, which are located in the same or different plural server racks. The server and network racks are often distributed in a cooled and ventilated room to avoid or minimize server overheating.

The temperature of a computing device, such as a server, typically increases with computing load. Unfortunately, device-computing reliability decreases as temperature increases. As temperature increases, circuit electrical resistance increases, which may further increase device temperature and reduce computing system reliability. Overheating computing resources may malfunction, thereby reducing system capacity and reliability.

To reduce device overheating in data-center applications, one or more personnel in charge of monitoring a data center often periodically walk about the data center room to observe thermometers positioned on various isles between the server racks. When a certain server or isle becomes excessively hot, the personnel often turn off devices or increase air-conditioning to prevent device failure. Unfortunately, excessive air-conditioning may consume additional energy without preventing overheating of overloaded devices. Furthermore, turning off devices may adversely affect data center performance. Turning off devices is particularly problematic when the data center is experiencing high loads, when data center components are most likely to overheat.

### BRIEF DESCRIPTION OF THE DRAWINGS

FIG. 1 is a diagram illustrating a system for selectively controlling computing-resource allocation based on sensed environmental variables according to a first embodiment of the present invention.

FIG. 2 is a flow diagram of a method adapted for use with the system of FIG. 1.

FIG. 3 is a diagram illustrating a data center employing a system for automatically adjusting data-center temperature distribution by controlling power supplies, cooling systems, processor speeds, and virtual-machine locations in response to a temperature map of the data center.

FIG. 4 is a flow diagram of a first method adapted for use with the data center of FIG. 3.

FIG. 5 is flow diagram of a second method adapted for use with the data center of FIG. 3.

FIG. 6 is a side view illustrating exemplary sensor positioning in a data center floor plan that is suitable for use with the systems and methods of FIGS. 1-6.

FIG. 7 is a top view illustrating exemplary sensor positioning and cooling-unit positioning in a data center floor plan that is suitable for use with the systems and methods of FIGS. 1-6.

### DESCRIPTION OF EMBODIMENTS OF THE INVENTION

A preferred embodiment of the present invention provides a system and method for affecting computing resources. The method involves sensing variables, such as temperature and humidity, associated with spatially dispersed computing resources and then providing sensed data in response thereto. Subsequently, the spatially dispersed computing resources are selectively automatically affected based on sensed variables associated with the computing resources. For example, computer processes, such as server applications running on hot resources, may be automatically reprovisioned to cooler resources via virtualization techniques. Alternatively, the computing resources may be cooled by a cooling unit that is activated when the sensed data meet predetermined criteria.

For clarity, various well-known components, such as power supplies, communications ports, operating systems, Internet Service Providers (ISPs), and so on have been omitted from the figures. However, those skilled in the art with access to the present teachings will know which components to implement and how to implement them to meet the needs of a given application.

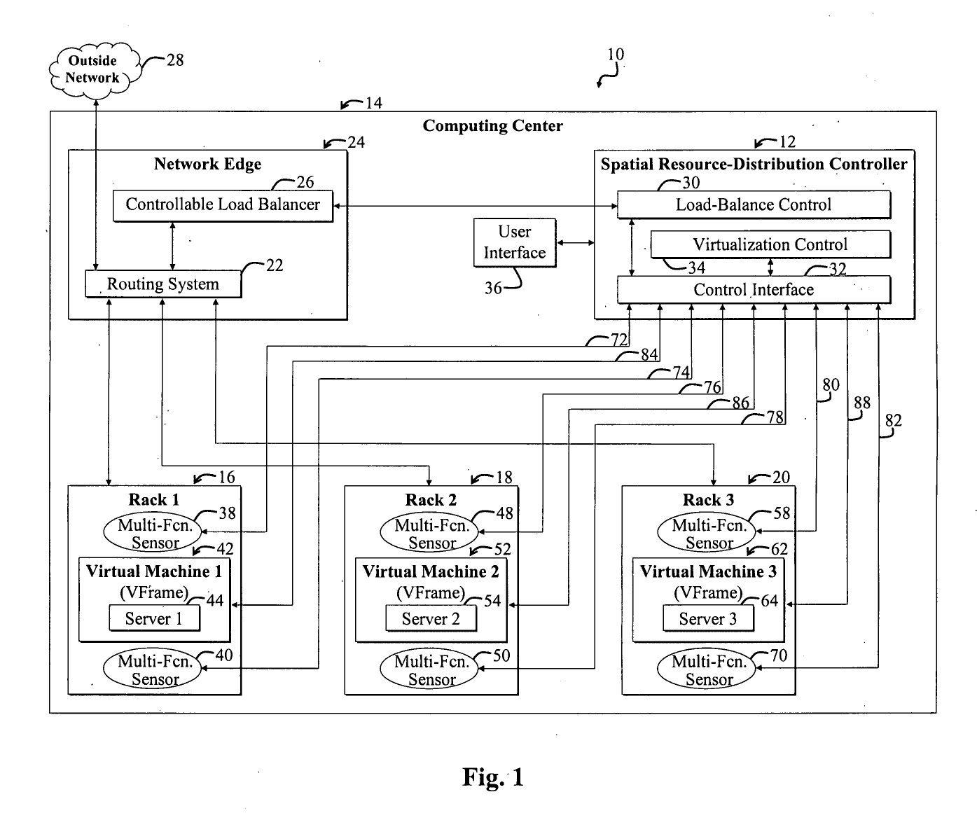

FIG. 1 is a schematic diagram illustrating a system 10 for selectively controlling computing-resource allocation based on sensed environmental variables according to a first embodiment of the present invention. The system 10 includes a spatial resource-distribution controller (controller) 12 running on a computing center 14, such as a Cisco® Data Center.

For the purposes of the present discussion, an environmental variable may be any data describing a physical characteristic of a region. Examples of environmental variables include temperature and humidity values. Computing resources may be any hardware or software involved in implementing a data-processing, data-movement, and/or data-storage function. Examples of computing resources include switches, server racks, computers, processors, memory devices, and applications.

For illustrative purposes, the computing center 14 is shown including a first computer 16, a second computer 18, and a third computer 20, which are networked via a routing system 22 running on a network edge 24. The routing system 22 further communicates with a controllable load balancer 26 in the network edge 24 and with an outside network 28, such as the Internet.

The controllable load balancer 26, which may be implemented as a server load balancer in certain implementations, is responsive to control signals from a load-balance control module 30 running on the spatial resource-distribution controller 12. The spatial resource-distribution controller 12 further includes a control interface 32 and a virtualization control module 34. The control interface 32 communicates with the computers 16-20 and provides sensed data to the load-balance control module 30 and the virtualization control module 34. The load-balance control module 30 and the virtualization control module 34 selectively route control signals to the computers 16-20 through the control interface 32 based on analysis of the sensed data. A user interface 36 further communicates with the spatial resource-distribution controller 12.

For illustrative purposes, the first computer 16 is shown including a first top multi-function sensor 38, a first bottom multi-function sensor 40, and a first virtual machine 42 within which is running a first virtualized server 44. Similarly, the second computer 18 includes a second top multi-function sensor 48, a second bottom multi-function sensor 50, and a second virtual machine 52 within which is running a second virtualized server 54. Similarly, the third computer 20 includes a third top multi-function sensor 58, a third bottom multi-function sensor 70, and a third virtual machine 62 within which is running a third virtualized server 64.

The multi-function sensors 38, 40, 48, 50, 58, 70 provide sensor signals 72-82, respectively, to the control interface 32 of the controller 12. The sensor signals 72-82 sent from the computers 16-20 to the controller 12 represent sensed data pertaining to certain environmental variables, such as temperature.

Sensor signals 72-82 forwarded from the controller 12 to the multi-function sensors 38, 40, 48, 50, 58, 70 represent sensor-control signals. The sensor-control signals may be employed by the controller 12 to selectively enable sensing of different types of environmental variables, such as temperature, humidity, dust levels, vibration levels, and/or sound levels. The multi-function sensors 38, 40, 48, 50, 58, 70 may be replaced with single-function non-controllable sensors, such as electronic thermometers, without departing from the scope of the present invention.

The virtual machines 42, 52, 62 communicate with the controller 12 via virtual-machine control signals 84, 86, 88, respectively. The virtual machines 42, 52, 62 are said to encapsulate the virtualized servers 44, 54, 64. For the purposes of the present discussion, the terms to encapsulate and to virtualize are employed interchangeably. To encapsulate means to implement a process or application so as to enable the process or application to be readily portable from one computing resource to another.

In the present specific embodiment, the Cisco® VFrame tool set is employed to implement the virtual machines 42, 52, 62. However, other virtualization mechanisms, such as VMWare® software may be employed to meet the needs of a given implementation of the present invention without departing from the scope thereof.

For the purposes of the present discussion, a virtualized computing process or application may be a process or application that is associated with a layer of abstraction, called a virtual machine, that decouples physical hardware from the process or application. A virtual machine may have so-called virtual hardware, such as virtual Random Access Memory (RAM), Network Interface Cards (NICs), and so on, upon which virtualized applications, such as operating systems and servers, are loaded. The virtualized computing processes may employ a consistent virtual hardware set that is substantially independent of actual physical hardware:

Computing processes and applications in addition to or other than servers may be virtualized and selectively moved via certain embodiments of the present invention without departing from the scope thereof.

In operation, in the present specific embodiment, the computing center 14 represents a network that is connected to the outside network 28. The network edge 24 and accompanying routing system 22 facilitate routing information and requests, such as requests to view web pages, between the outside network 28 and the computers 16-20 of the computing center 14.

In one operating scenario, excessive processing demands on the servers 44, 54, 64 and accompanying computers 16-20, may cause the computers 16-20 or sections thereof to be come undesirably hot. Hot temperatures at different locations within the computers 16-20 are reported to the virtualization control module 34 of the spatial resource-distribution controller 12 via the control interface 32. The control interface 32 may maintain a temperature map based on temperature data received from the multi-function sensors 38, 40, 48, 50, 58, 70. Certain regions of the temperature map, corresponding to locations within the computers 16-20, may become hotter than a predetermined threshold. The virtualization control module 34 then activates virtualization functionality running on the computers 16-20 to transfer servers and accompanying virtual machines from relatively hot computing regions to cooler computing regions, which may or may not be located on different computers or server racks. Hence, the virtualization control module 34 automatically spatially moves computing processes among computing resources 16-20 in response to sensed environmental variables, such as temperature.

In another exemplary operating scenario, a leaky roof in a building accommodating the computing center 14 may cause excessively humid conditions for a given computer, such as the first computer 16. To ensure reliability of processes and applications running on computers associated with humid conditions, the processes and applications are automatically moved when predetermined humidity criteria are met. When the humidity criteria are met, such as when detected humidity levels surpass a predetermined humidity threshold, the virtualization control module 34 triggers automatic movement of computing processes and applications from the humid region to one or more computers 18, 20 associated a less humid regions.

For example, in one exemplary scenario, spilled cleaning fluid entering the bottom of the first computer 16 may increase humidity levels detected by the first bottom multi-function sensor 40. The humidity levels may surpass the predetermined humidity threshold as determined by the virtualization control module 34. The virtualization control module 34 then communicates with the virtualization software 42 to automatically move the associated computing processes 42 running near the bottom of the computer 16 to another computer, such as the third computer 20, which may not be in the spill area. Movement of the virtual machines 42, 52, 62 to different machines may occur through the routing system 22 in response to appropriate signaling from the controller 12.

The virtualization functionality required to effectuate automatic movement of a virtualized server 44, 54, 64 to different computers is represented by the virtual machines 42, 52, 62. The virtualization functionality may be implemented via one or more virtualization tool sets, such as Cisco® VFrame or VMWare® software packages.

Each of the computers 16-20 may run plural virtualized servers without departing from the scope of the present invention. Furthermore, while the applications running on the computers 16-20 are illustrated as servers encapsulated by virtual machines, other types of virtualized applications may be moved via the virtualization controller 34 without departing form the scope of the present invention. In addition, each of the computers 16-20 may be replaced with plural computers and/or processors, server racks, or other computing resources without departing from the scope of the present invention.

The virtualization control module 34 may be implemented in software and/or hardware. Exact implementation details to implement various modules, such as the virtualization control module 34, are application specific and may be readily determined by those skilled in the art to meet the needs of a given application without undue experimentation.

Various predetermined thresholds, such as temperature thresholds, humidity thresholds, dust-level thresholds, and so on, employed by the virtualization control module 34 and the load-balance control module 30 may be provided and/or changed via the user interface 36.

The load-balance control module 30 operates similarly to the virtualization control module 34 with the exception that the load-balance control module 30 does not spatially move processes and applications associated with virtual machines. Instead, the load-balance control module 30 sends control signals to the controllable load balancer 26, which are sufficient to adjust the routing of requests and related operations between the outside network 28 and the computers 16-20. For example, when the first computer 16 begins to overheat, the load-balance control module 30 may adjust the routing system 22 via the load balancer 26 to trigger a shift in computing load from first server 44 running on the first computer 16 to another server 54 or 64 running on a different computer 18 or 20, respectively.

The system 10 facilitates selectively spatially affecting computing resources in response to sensed data. In the present specific embodiment, the system 10 relies upon the resource-distribution controller 12, virtualization functionality 42, 52, 62, and sensed data from the plural sensors 38, 40, 48, 50, 58, 70. The system 10 may be employed to automatically adjust computing resources 16-20 by moving accompanying processes 42, 52, 62 in response to a fire, leaky roof, excessive temperature, and so on. Such automatic spatial adjustment of computing resources and processes is particularly important in data center computing applications, where reliability is often critical.

The system 10 may also facilitate computing-resource life-cycle trending operations; may facilitate maximizing computing resources without reducing mean time between failure; may facilitate gaining knowledge of performance versus temperature characteristics for a given computing resource; may reduce the need for servers in a data center to be distributed throughout a room as is conventionally done for cooling purposes; may result in power savings by reducing excessive use of cooling systems; may facilitate extending the life of computing resources by maintaining cooler operating environments; and so on. Furthermore, principles employed by the system 10 may be adapted to automatically turn off computing resources, place resources in standby mode when demand is light, and so on, without departing from the scope of the present invention.

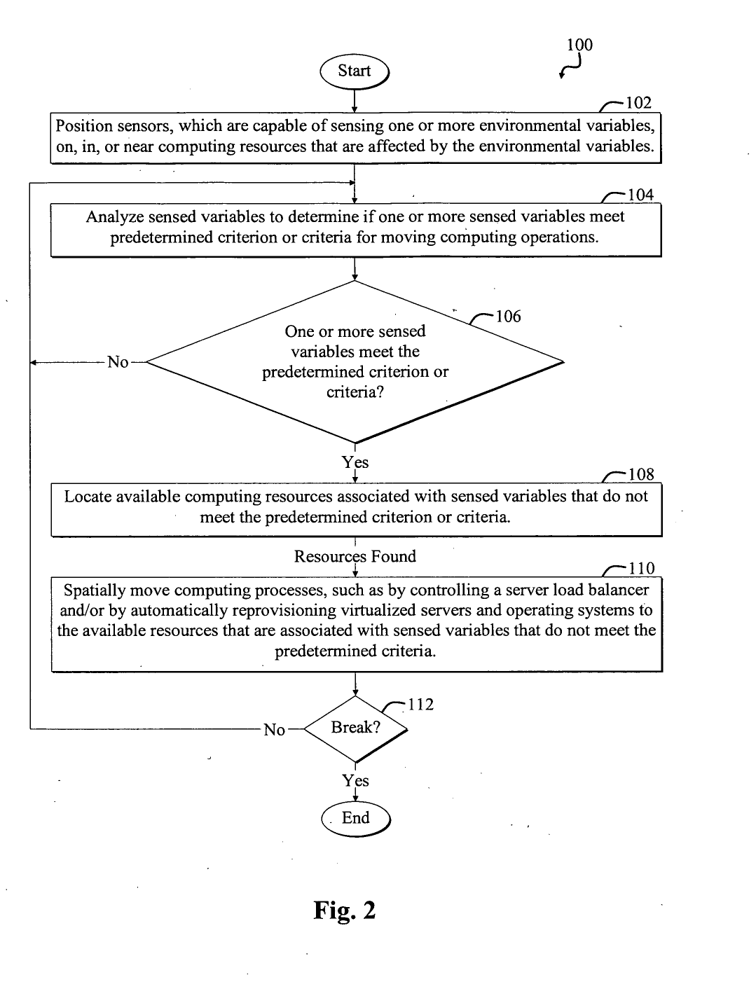

FIG. 2 is a flow diagram of a method 100 that is adapted for use with the system 10 and accompanying computing center 14 of FIG. 1. The method 100 includes an initial sensor-positioning step 102, wherein sensors, such as the sensors 38, 40, 48, 50, 58, 70 of FIG. 1, are positioned are positioned on, in, or near computing resources, such as the computers 16-20 of FIG. 1. The sensors are capable of sensing one or more environmental variables. In the present specific embodiment, only environmental variables that may affect computing resources and/or accompanying computing processes are sensed by the sensors.

In a subsequent analyzing step 104, sensed data output from the sensors that were positioned during the positioning step 102 is analyzed to determine if one or more sensed variables meet a predetermined criterion or set of criteria. An example predetermined criterion specifies that when a given temperature measurement surpasses a given threshold value, or the rate of temperature increase surpasses a predetermined threshold value, then the criterion is satisfied.

If one or more of the sensed environmental variables meet the predetermined criterion or criteria as determined in a subsequent criteria-checking step 106, then a resource-locating step 108 is performed next. Otherwise, the analyzing step 104 continues.

The resource-locating step 108 includes locating available computing resources that are associated with sensed variables that not meet the predetermined criterion or criteria. When the available computing resources are found, a resource-reprovisioning step 110 is then performed.

The resource-reprovisioning step 110 includes spatially moving computing processes and/or resources, such as by controlling a load balancer and/or by automatically reprovisioning virtualized applications to the available resources that do not meet the environmental-variable criteria for moving resources.

Subsequently, a break-checking step 112 is performed. The break-checking step 112 determines whether a system break has occurred. A system break may occur when the system 10 of FIG. 1 is turned off or otherwise deactivated, such as via the user interface 36 of FIG. 1. If a break has occurred, the method 90 completes. Otherwise, the analysis step 104 continues.

Various steps 102-112 of the method 90 may be replaced, modified, or interchanged with other steps without departing from the scope of the present invention. For example, the resource-reprovisioning step 110 may include further steps, wherein a second criterion or set of criteria is employed to select a computing resource to which to move virtualized applications. The second set of criteria may specify, for example, that the computing resource exhibiting the coolest temperatures and the most available resources be selected to accommodate virtualized applications from one or more excessively hot regions.

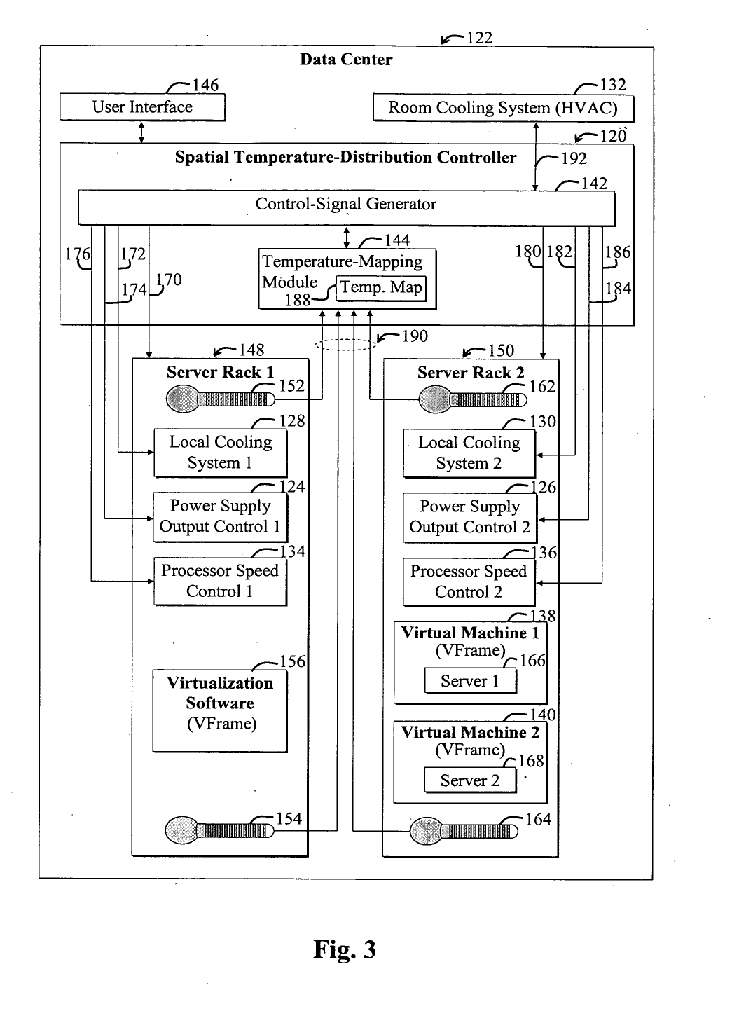

FIG. 3 is a schematic diagram of illustrating a data center 122 employing a system 120 for automatically adjusting data-center temperature distribution by controlling power supplies 124, 126, cooling systems 128, 130, 132 processor speed-control modules 132, 134, 136 and locations of virtual machines 138, 140 based on a temperature map of the data-center 122. For clarity, routers and other modules interconnecting various components of the data center 122 are not shown.

The data center 122 includes a spatial temperature-distribution controller 120, which includes a control signal generator 142 that communicates with a temperature-mapping module 144. The spatial temperature-distribution controller 120 is configurable via a user interface 146 and further communicates with a first server rack 148 and a second server rack 150.

The first server rack 148 includes a first top-of-rack temperature sensor 152 and a first bottom-of-rack temperature sensor 154. The first server rack 148 also includes a first local cooling system 128, a controllable power supply 124, a processor-speed control module 134, and virtualization software 156, such as Cisco® VFrame.

Similarly, the second server rack 150 includes a second top-of-rack temperature sensor 162, a second bottom-of-rack temperature sensor 164, a second local cooling system 130, a second controllable power supply 126, a second processor speed-control module 136, a first virtual machine 138 and accompanying server 166, and a second virtual machine 140 and accompanying server 168.

The control-signal generator 142 of the spatial temperature-distribution controller 120 provides control signals 170-176 to the first server rack 148 and accompanying virtualization software 156, to the first cooling system 128, to the first controllable power supply 124, and to the first processor-speed control module 134, respectively. Similarly, the control signal generator 142 provides control signals 180-186 to the second server rack 150 and accompanying virtual machines 138, 140, to the second cooling system 130, to the second controllable power supply 126, and to the second processor-speed control module 136, respectively.

The control-signal generator 142 selectively generates the control signals 170-176, 180-186 based on a temperature map 188 of the server racks 148 that is maintained by the temperature-mapping module 144. The temperature-mapping module 144 forms the temperature map 188 based on preestablished knowledge of the positions of the temperature sensors 152, 162, 154, 164 and based on temperature data received from the temperature sensors 152, 162, 154, 164 via temperature signals 190.

The temperature map 88 may maintain additional computing-resource-allocation information. For the purposes of the present discussion, computing-resource-allocation information may be any information indicating how computing resources are allocated. For example, information specifying where the first virtual machine 138 and the second virtual machine 140 are running represents computing-resource-allocation information. Such information may be maintained and tracked by the temperature-mapping module 144 or the control-signal generator 142 to facilitate moving resources. Alternatively, such computing-resource-allocation information is reported by computing resources, such as the server racks 148, 150 to the control-signal generator 142 in response to a query from the control-signal generator 142.

In operation, the control-signal generator 142 runs an algorithm that is adapted to eliminate excessively hot spots in the temperature map 188 of the server racks 148, 150. The control-signal generator 142 eliminates hot spots by selectively controlling the processor-speed control modules 134, 136, the controllable power supplies 124, 126, the local cooling systems 128, 130, the room Heating Ventilation and Air Conditioning (HVAC) cooling system 132 via an HVAC control signal 192, and by controlling computing-resource allocation. Computing-resource allocation is controlled by selectively moving applications, such as the first server 166 and the second server 168 between and/or among server racks 148, 150 via the virtualization software 156, 138, 140. For the purposes of the present discussion, excessively hot spots represent regions associated with temperatures that surpass predetermined threshold values.

The various temperature sensors 152 162, 154, 164 may be positioned in different locations, and/or additional or fewer temperature sensors may be employed without departing from the scope of the present invention. For example, additional temperature sensors may be distributed throughout the data center 122, not just within the server racks 148, 150.

Furthermore, additional or fewer mechanisms for automatically adjusting the temperature map 188 may be employed. For example, one or modules capable of placing one or more operating systems running on the server racks 148, 150 in standby mode in response to a control signal from the control-signal generator 142 may be employed. Furthermore, additional server racks and/or other types of computing resources may be selectively cooled via the spatial temperature-distribution controller 120. Such additional resources may be associated with temperature sensors and may be further equipped with one or more devices that are responsive to control signals from the control-signal generator 142 to effect appropriate temperature changes.

Note that conventionally, hot spots in server racks were often addressed by turning up the room cooling system 132. Unfortunately, in some applications, the data center room 122 would have to become prohibitively cold to eliminate hot spots in the server racks 148, 150. The excessive power consumed by the cooling system 132 in such applications was problematic.

The spatial temperature-distribution controller 120, temperature sensors 152, 162, 154, 164, and controllable modules 128-140, 56 facilitate implementing a system that may provide visibility into ‘hot zones’ in data centers based on a measurements of inlet-ambient temperature on Top-of-Rack switches (4948s, SFS 7000s). The temperature measurements are then correlated into a physical map of the data center 122.

Based on an increasing and thresholding temperature in a particular rack of servers 148, 150, in the data center 122 the VFrame provisioning system 138, 140, 142, may dynamically reallocate the computing capacity to a location in the data center 122 with similar compute capability, but lower temperatures. This is a loosely coupled system 120, 152, 162, 154, 164, 128-140, 56 in that it does not require tying into (but may tie into) HVAC systems or external temperature sensors, but it still allows for dynamic re-apportionment of computing capacity and topography to align with changing thermal capacity and hot spots in the data 122 center. Embodiments of the present invention may be coupled with Cisco® Content Switching Module (CSM) Load Balancers and related devices to also throttle the number and bandwidth of open sockets and to drive server utilization in the hot spots.

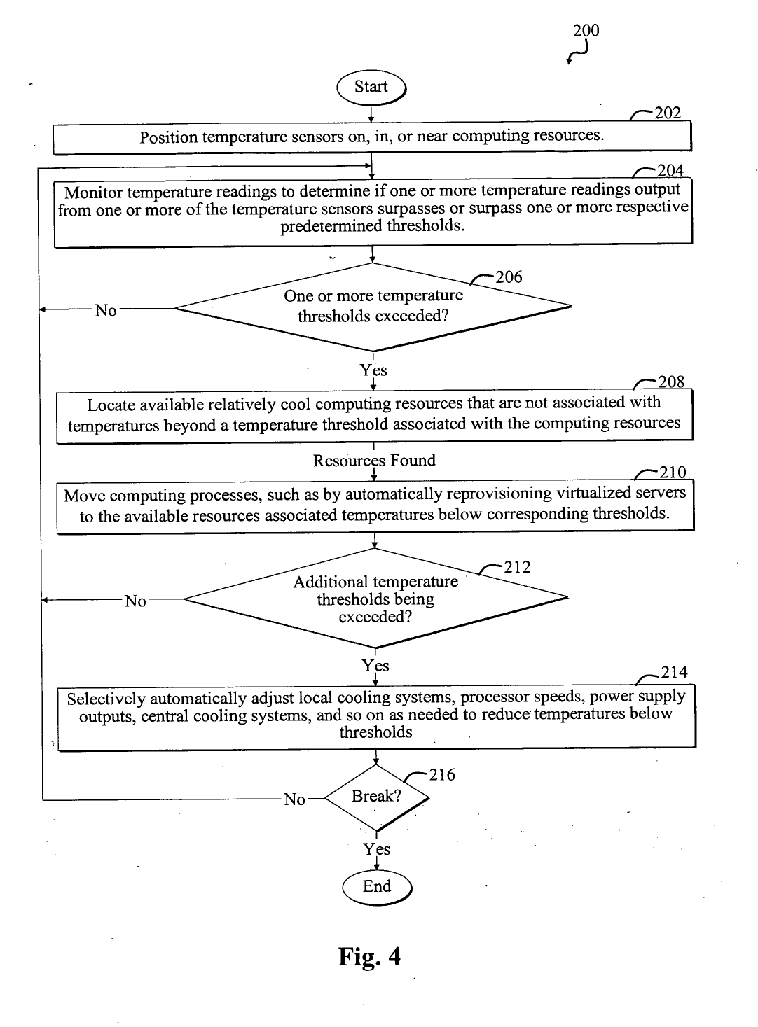

FIG. 4 is a flow diagram of a method 200 adapted for use with the data-center 122 of FIG. 3. The method 200 includes an initial temperature-sensor positioning step 202, wherein temperature sensors, such as the temperature sensors 152 162, 154, 164 of FIG. 3, are positioned near computing on, in, or near computing resources, such as the server racks 148, 150 of FIG. 3.

A subsequent temperature-monitoring step 204 includes monitoring temperature readings from the temperature sensors to determine if one or more temperature readings output from one or more of the temperature sensors surpasses or surpass one or more respective temperature thresholds. If one or more temperature thresholds are surpassed as determined in a subsequent threshold-checking step 206, then a resource-locating step 208 is performed. Otherwise, the temperature-monitoring step 204 continues.

The resource-locating step 208 includes locating available computing resources that are not associated with temperatures beyond the temperature threshold. When the most suitable resources are found, then computing processes are moved to the cooler resources via a reprovisioning step 210.

A subsequent additional threshold-monitoring step 212 checks the temperature readings to determine if any additional temperature thresholds have been exceeded or the original temperature thresholds remain exceeded. If so, then a hardware-adjusting step 214 is performed.

The hardware-adjusting step 214 includes selectively automatically adjusting local cooling systems, processor speeds, power supplies, and/or cooling systems as needed to reduce temperatures to desired levels.

A subsequent break-checking step 216 selectively ends the method 200 in response to detection of a system break. Otherwise, the monitoring step 204 continues.

Various steps 202-214 may be omitted, interchanged, or modified without departing from the scope of the present invention. For example, steps involving use of one or more predetermined thresholds may be omitted. For example, an alternative embodiment may include periodically moving processes associated with the hottest resources to the coolest available resources despite whether or not a predetermined threshold is met.

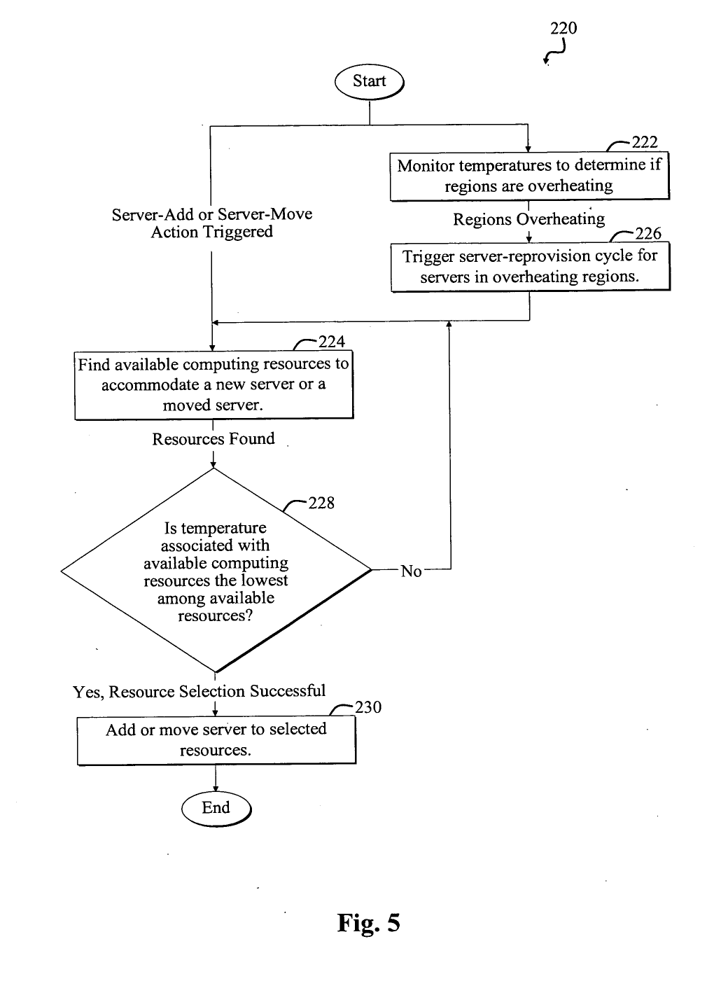

FIG. 5 is flow diagram of a second method 220 that is adapted for use with the data center 122 of FIG. 3. The method 220 begins when a server-add or a server-move action is triggered, such as by the temperature-distribution controller 120 of FIG. 3, or when a temperature-monitoring step 222 begins. Note that the method 220 may begin without an initial server-add or server-move action triggered by the temperature-distribution controller 120 of FIG. 3. For example, another module (not shown) may trigger the server-add or server-move action without departing from the scope of the present invention.

When the temperature-distribution controller 120 triggers the server-add or server-move action, the method 220 begins with the temperature-monitoring step 222. The temperature-monitoring step 222 includes monitoring temperatures associated with computing resources to determine when particular regions overheat. When one or more regions begin to overheat, a reprovision-triggering step 226 is performed, wherein a server-add and/or server-move action is triggered, such as via virtualization software 156 in response to a control signal 170 from the temperature-distribution controller 120 of FIG. 3.

Subsequently, a resource-finding step 224 is performed. The resource-finding step 224 includes locating available computing resources to accommodate a new server or a server moved from an overheating zone. If available resources are found, a temperature-checking step 228 is performed for the available resources.

If the temperature-checking step 228 determines that the available resources to not exhibit sufficiently low temperatures, then the resource-finding step 224 continues. Otherwise, resource selection was successful, upon which a new server is added to the available resource, or the server from the overheating zone is moved to the available resource in a server-adding/moving step 230.

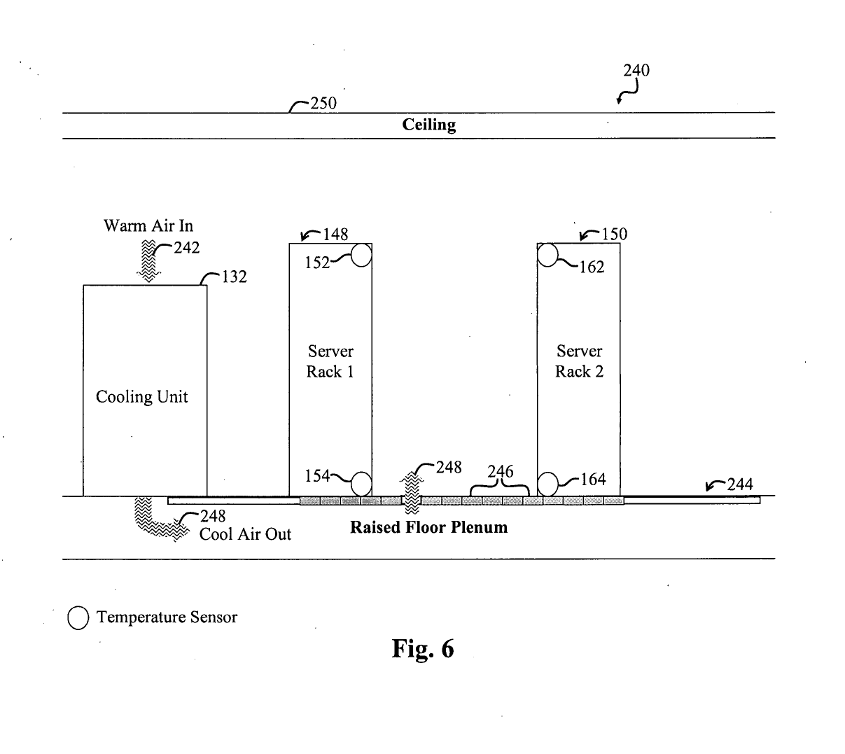

FIG. 6 is a side view illustrating exemplary sensor positioning in a data center floor plan 220 that is suitable for use with the systems and methods of FIGS. 1-6. With reference to FIGS. 3 and 6, the data center floor plan 220 shows the room cooling system 132 removing warm air 242 from the room 240 and outputting cooled air 248 into a raised floor plenum 244 equipped with removable floor tiles 246. To facilitate cooling hot regions in the room 240, floor tiles 246 are selectively removed in hot areas to allow the cool air 248 to flow into the hot regions.

The selectively removable floor tiles 246 are employed in combination with the strategically placed temperature sensors 152, 162, 154, 164 of the server racks 148, 150 and the spatial temperature-distribution controller 120 or FIG. 3. In the present specific embodiment, a data-center ceiling 250 is made relatively low to reduce requisite cooling space, thereby further saving energy.

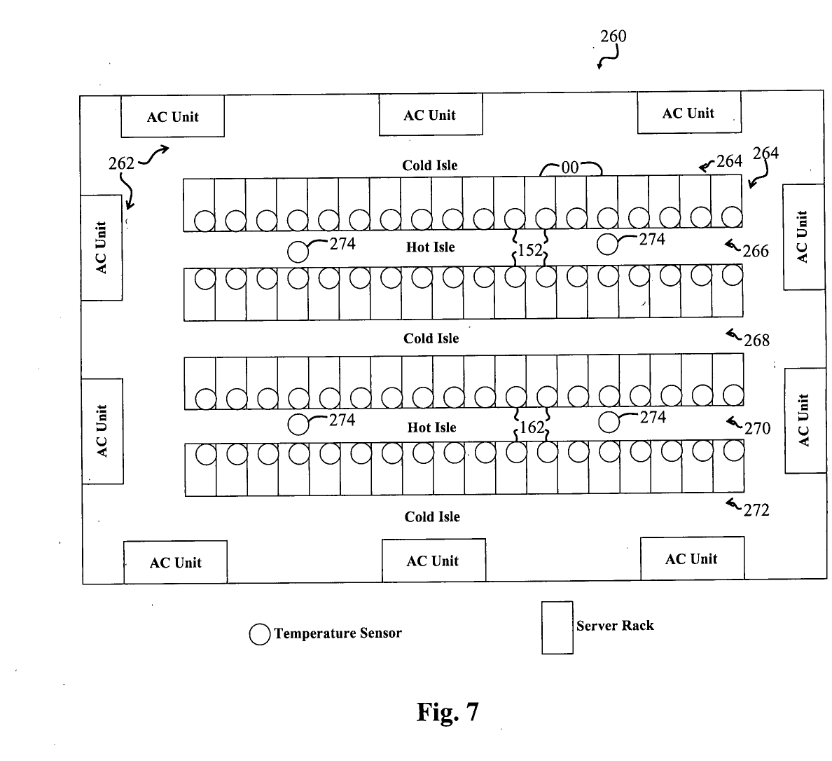

FIG. 7 is a top view illustrating exemplary sensor positioning and cooling-unit positioning in a data-center floor plan 260 that is suitable for use with the systems and methods of FIGS. 1-6. The floor plan 260 includes plural air-conditioning units (AC units) 262, which are positioned along the perimeter of the data-center floor plan 260. The data-center floor plan 260 includes plural rows of servers 264, each server being equipped with temperature sensors 152, 162. Various isles 264-272 between the server rows 264 alternate between relatively hot and relatively cool isles. Isles 266, 270 that tend to be hotter are equipped with additional isle-temperature sensors 274.

In the present specific embodiment, all of the temperature sensors 152, 162, 274 and the AC units 262 are adapted to send sensed temperature data to a temperature-distribution controller, such as the temperature-distribution controller 120 of FIG. 3, which may then make AC-unit adjustments and/or server-reprovisioning and/or load-balancing adjustments in response thereto.

While the present embodiment is discussed with reference to data center and accompanying computing environments, embodiments of the present invention are not limited thereto. For example, many types of computing environments, wired or wireless, may benefit from selective automatic control of environmental variables via embodiments of the present invention.

Although a process or module of the present invention may be presented as a single entity, such as software executing on a single machine, such software and/or modules can readily be executed on multiple machines. Furthermore, multiple different modules and/or programs of embodiments of the present invention may be implemented on one or more machines without departing from the scope thereof.

Any suitable programming language can be used to implement the routines or other instructions employed by various network entities. Exemplary programming languages include C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “machine-readable medium” or “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow “a”, “an”, and “the” include plural references unless the context clearly dictates otherwise. Furthermore, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for spatially affecting computing resources comprising:
sensing variables associated with one or more spatially dispersed computing resources and providing sensed data in response thereto; and
automatically selectively adjusting the one or more spatially dispersed computing resources based on sensed variables associated therewith.

2. The method of claim 1 wherein the step of automatically adjusting includes
determining if the sensed data meet a predetermined criterion or criteria and providing one or more control signals in response thereto.

3. The method of claim 2 wherein the one or more spatially dispersed computing resources include
one or more virtual machines.

4. The method of claim 3 wherein the step of automatically adjusting further includes
moving one or more virtual machines associated with one or more computing resources that meet the predetermined criteria to one or more computing resources that do not meet the predetermined criterion or criteria.

5. The method of claim 4 wherein the sensed data includes
temperature data.

6. The method of claim 5 wherein the predetermined criteria or criterion includes
a predetermined threshold beyond which temperature data is considered to meet the predetermined criteria or criterion.

7. The method of claim 2 wherein the step of automatically adjusting further includes
adjusting operations of a load balancer to adjust loads experienced by one or more of the computing resources that are associated with sensed data that meets the predetermined criterion or criteria.

8. The method of claim 2 wherein the step of automatically adjusting further includes
selectively activating one or more devices that are adapted to alter sensed variables to cause the sensed data to no longer meet the predetermined criterion or criteria.

9. The method of claim 8 wherein the one or more devices include
one or more cooling systems, processor speed-control devices, or controllable power supplies.

10. A method for selectively distributing computing resources comprising:
sensing one or more environmental variables associated with one or more computing resources and providing a signal in response thereto; and
automatically affecting consumption of the one or more computing resources based on the signal.

11. A method for facilitating automatic reprovisioning of one or more computing resources comprising:
measuring temperature associated with the one or more computing resources and providing temperature data in response thereto; and
employing the temperature data to selectively spatially affect distribution of one or more computing processes among one or more of the one or more computing resources.

12. The method of claim 11 wherein the computing processes are encapsulated via
one or more virtual machines, the virtual machines being movable from one computer to another computer in response to a control signal from a controller that receives the temperature data as input.

13. A method for selectively moving one or more computing resources comprising:
measuring one or more environmental variables in a computing environment; and
selectively reprovisioning the one or more computing resources from a first system to a second system based on the one or more environmental variables.

14. The method of claim 13 wherein the second system is physically separate from the first system.

15. The method of claim 13 wherein the computing environment includes a
data center.

16. The method of claim 13 wherein the one or more environmental variables include
one or more temperature measurements as represented via a thermal map of the computing environment.

17. The method of claim 13 wherein the one or more environmental variables include
one or more humidity measurements.

18. A method for automatically affecting environmental variables in a computing environment comprising:
obtaining temperature and computing-resource-allocation information and generating a signal based on the information; and
employing the signal to selectively control one or more environmental variables associated with the computing environment.

19. The method of claim 18 wherein the temperature information includes
temperature distribution information.

20. The method of claim 18 wherein employing the signal includes
controlling the one or more environmental variables by spatially adjusting computing resource allocation.

21. The method of claim 18 wherein employing the signal includes
selectively controlling temperature distribution in the computing environment by adjusting computing resource allocation.

22. The method of claim 21 wherein adjusting computing resource allocation includes
electronically moving virtualized servers that are associated with relatively hot regions in the computing environment to computing resources that are associated with relatively cool resources in the computing environment.

23. The method of claim 18 wherein employing the signal includes
controlling temperature distribution in the computing environment by automatically adjusting cooling system.

24. A system for selectively distributing computing resources comprising:
first means for sensing one or more environmental variables associated with one or more computing resources and providing a signal in response thereto; and
second means for automatically affecting consumption of the one or more computing resources based on the signal.

25. The system of claim 24 wherein the first means includes
one or more temperature sensors that output temperature data.

26. The system of claim 25 wherein the first means includes
a controller, wherein the controller is adapted to receive temperature data and provide the signal in response thereto, wherein the signal is a control signal.

27. The system of claim 26 wherein the one or more computing resources include
plural computers.

28. The system of claim 27 wherein the second means includes
virtualized software running on each of the plural computers, the virtualized software being responsive to the control signal to affect spatial movement of processing functions performed on one computer to another computer.

29. The system of claim 27 wherein the computers include
one or more servers, and wherein the second means includes a server load balancer that adjusts usage of the one or more servers at least partially in response to the control signal.

30. An apparatus for spatially affecting computing resources comprising:
one or more processors;
a machine-readable medium including instructions executable by the one or more processors for
sensing variables associated with spatially dispersed computing resources and providing sensed data in response thereto and
automatically selectively affecting the spatially dispersed computing resources based on sensed variables associated therewith.

31. A computer-readable medium including instructions for selectively moving computing resources comprising, the computer-readable medium comprising:
one or more instructions for measuring environmental variables in a computing environment and
one or more instructions for selectively reprovisioning the computing resources from a first system to a second system based on the environmental variables.
